(19) United States
(12) Patent Application Publication
(10) Pub. No.: US 2002/0191845 A1
(43) Pub. Date: Dec. 19, 2002

(54) Method and apparatus for improving decompression and color space conversion speed

(76) Inventors: Harlan A. Talley, Vancouver, WA (US); Phillip McCoog, Vancouver, WA (US); Curtis J. Behrend, San Diego, CA (US)

Correspondence Address: HEWLETT-PACKARD COMPANY, Intellectual Property Administration, P.O. Box 272400, Fort Collins, CO, 80527-2400, US

(21) Appl. No.: 09/924,205

(22) Filed: Aug. 7, 2001

Related U.S. Application Data
(60) Provisional application No. 60/299,260, filed on Jun. 19, 2001.

(51) Int. Cl. G06K 9/00; G06K 9/36; G06K 9/46

(52) U.S. Cl. 382/166; 382/233; 382/250

(57) ABSTRACT

An embodiment of a conversion apparatus improves the speed of color space conversion while using the output of a Winograd inverse DCT algorithm. The conversion apparatus includes a normalization and clipping block to convert the YCaCb data generated from the inverse DCT operation. In addition, the conversion apparatus includes a color space conversion block that performs a color space conversion, using matrix multiplication, on the output of the normalization and clipping block.

### CROSS REFERENCE TO RELATED APPLICATIONS

The present application claims the benefit of United States Provisional application No. 60/299,260 (attorney's docket number 10006809-1), filed on Aug. 30, 2000, the entire disclosure of which is incorporated by reference herein.

### FIELD OF THE INVENTION

This invention relates to decompression and color space conversion in a data pipeline. More particularly, this invention relates to a method and apparatus for improving the speed of decompression and color space conversion in a data pipeline.

### BACKGROUND OF THE INVENTION

The Winograd algorithm is an efficient way to compute an inverse discrete cosine transform (DCT) used in decompression of data compressed in a JPEG compression process. However, the format generated by the algorithm is a non-standard format. Converting this non-standard format to a format that is usable in a data pipeline for subsequent operations performed in the pipeline requires computations that significantly decrease the overall speed at which a decompression operation can be performed. If an efficient way could be found to convert the format generated through the operation of the Winograd algorithm, an improvement in the decompression speed could be realized.

### DESCRIPTION OF THE DRAWINGS

A more thorough understanding of embodiments of the conversion apparatus may be had from the consideration of the following detailed description taken in conjunction with the accompanying drawings in which:

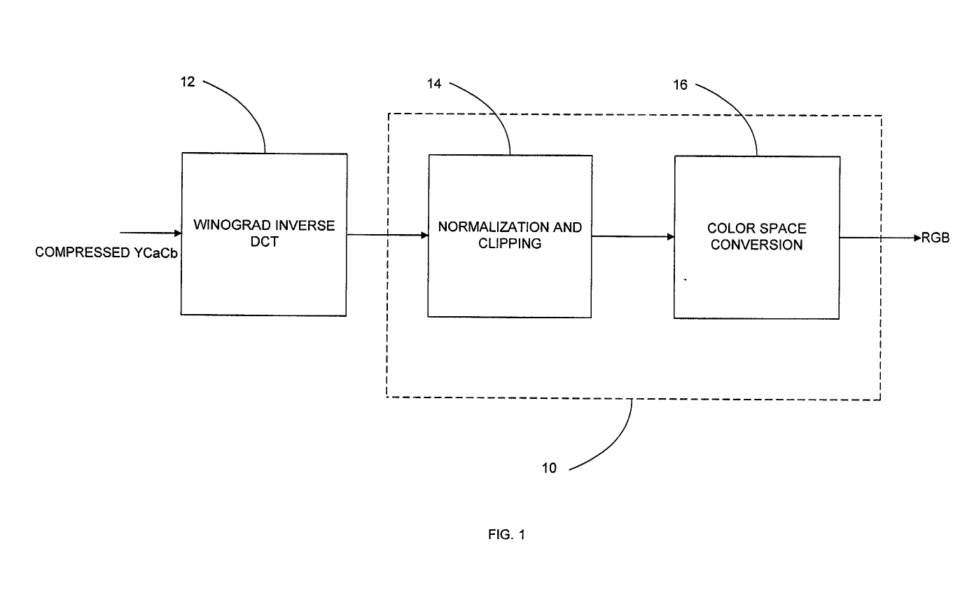

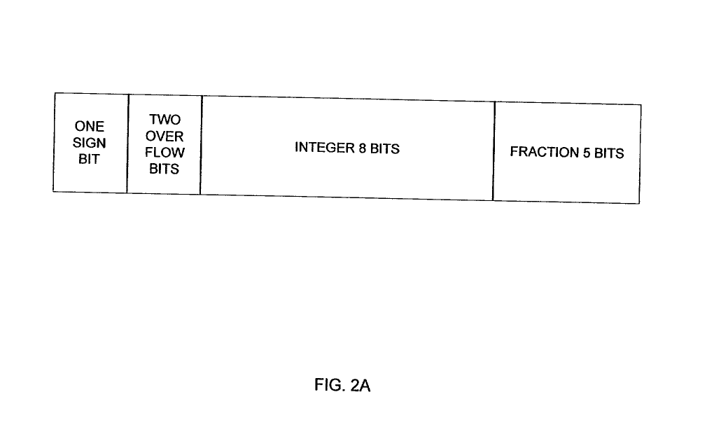

Shown in FIG. 1 is simplified block diagram of an embodiment of conversion apparatus.

Shown in FIGS. 2A and 2B are representations of the output from the Winograd algorithm

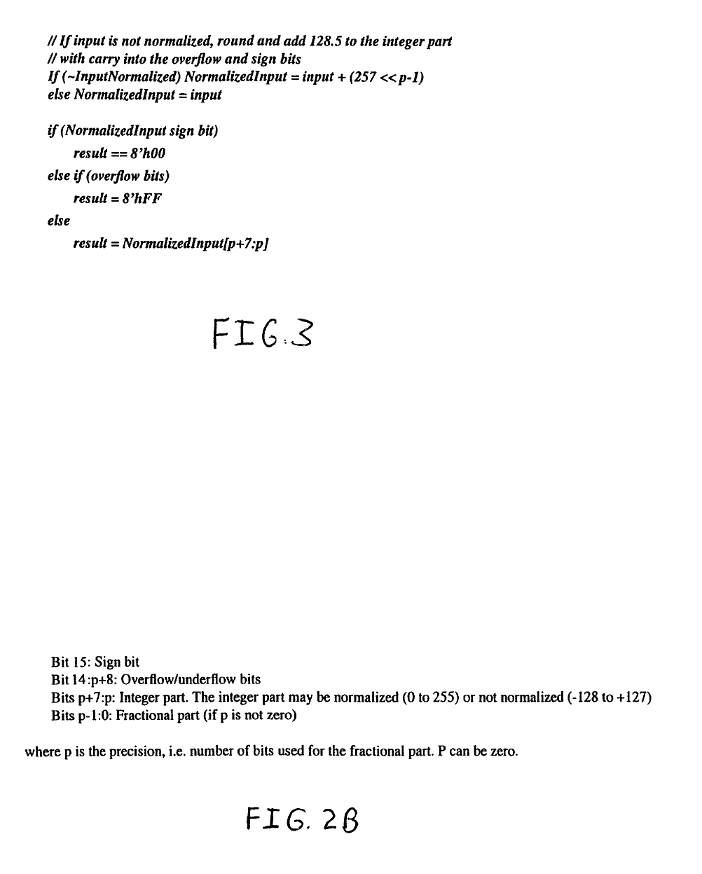

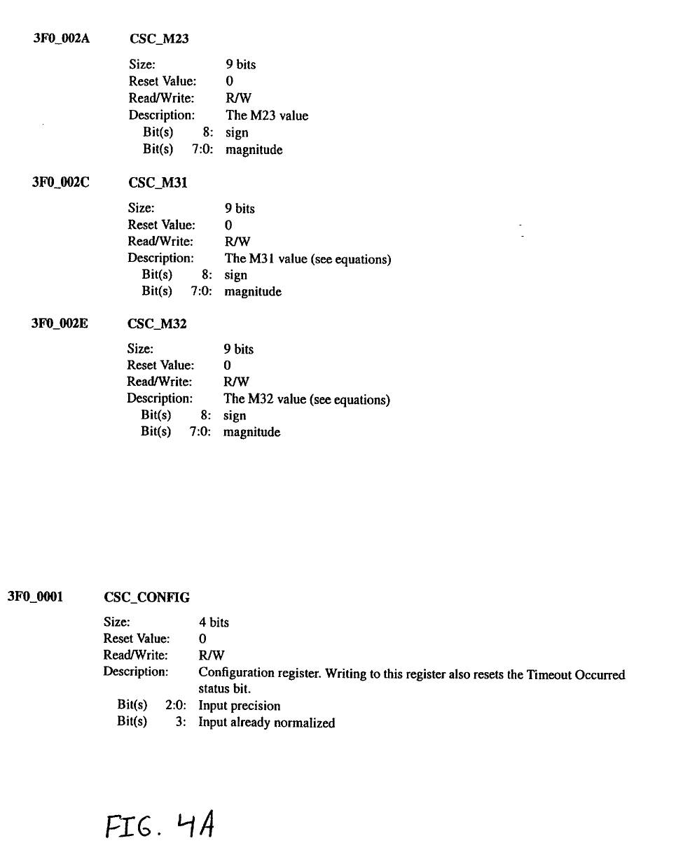

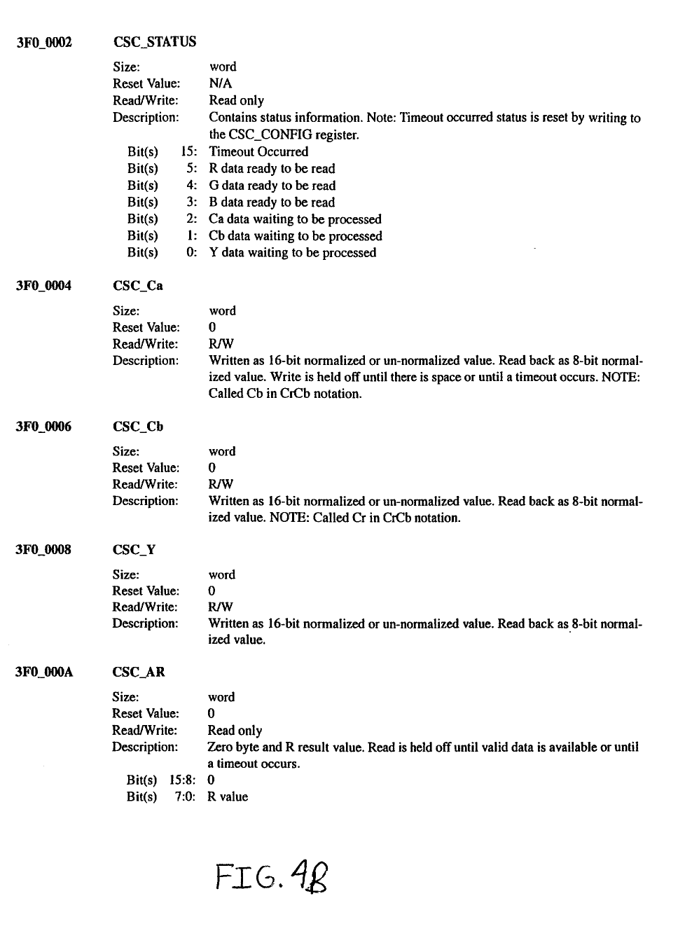

Shown in FIG. 3 is pseudo code representing the operation of normalization and clipping block 14.

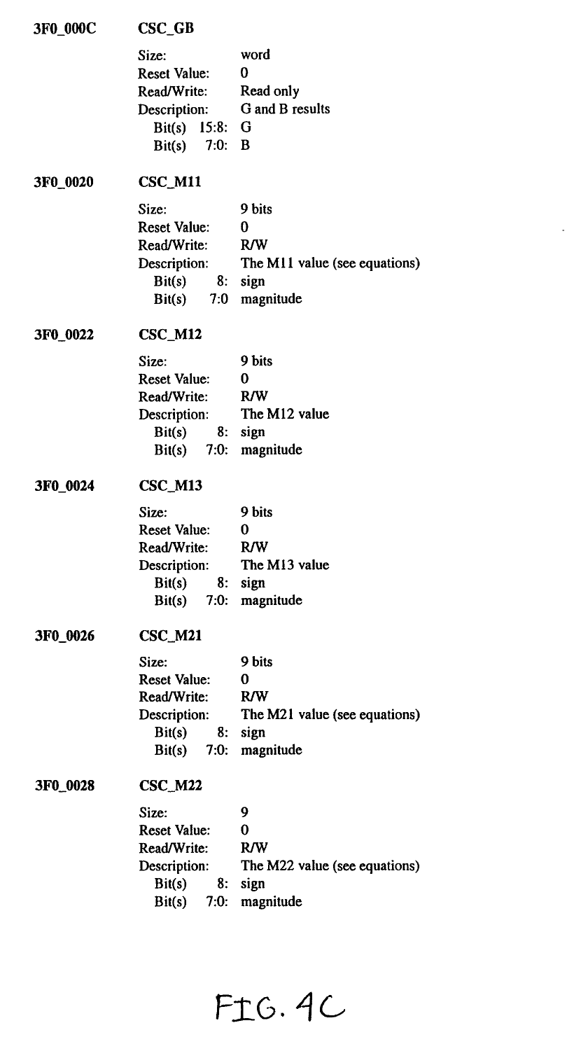

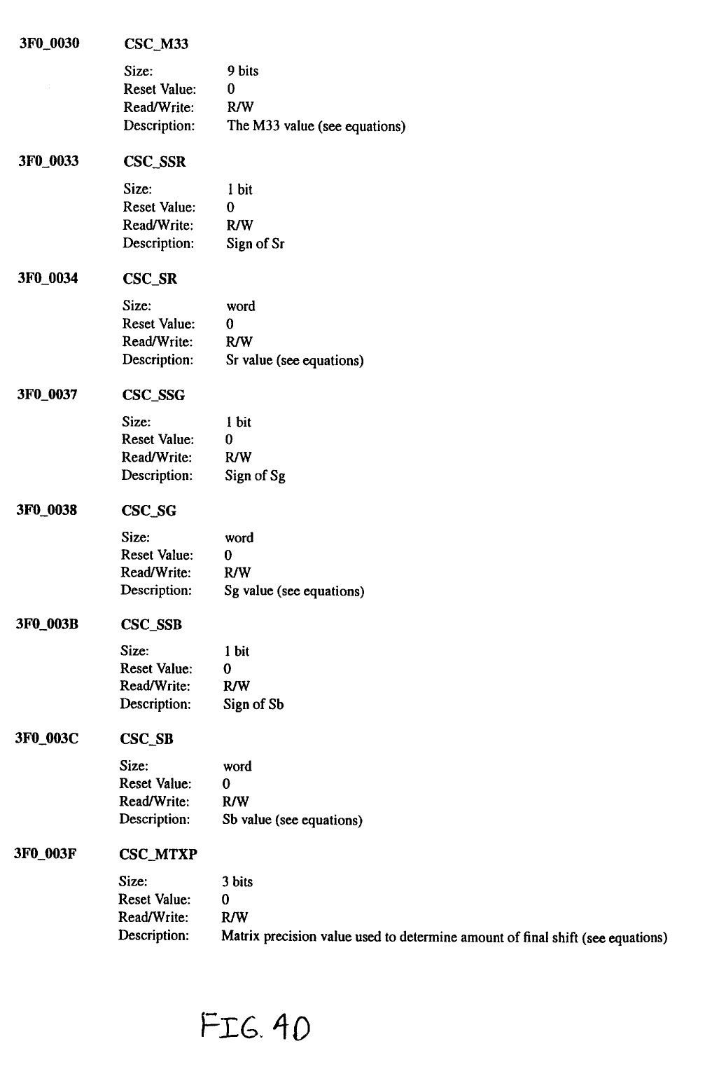

Shown in FIGS. 4A through 4D are register definitions for the hardware portion of an embodiment of the conversion apparatus.

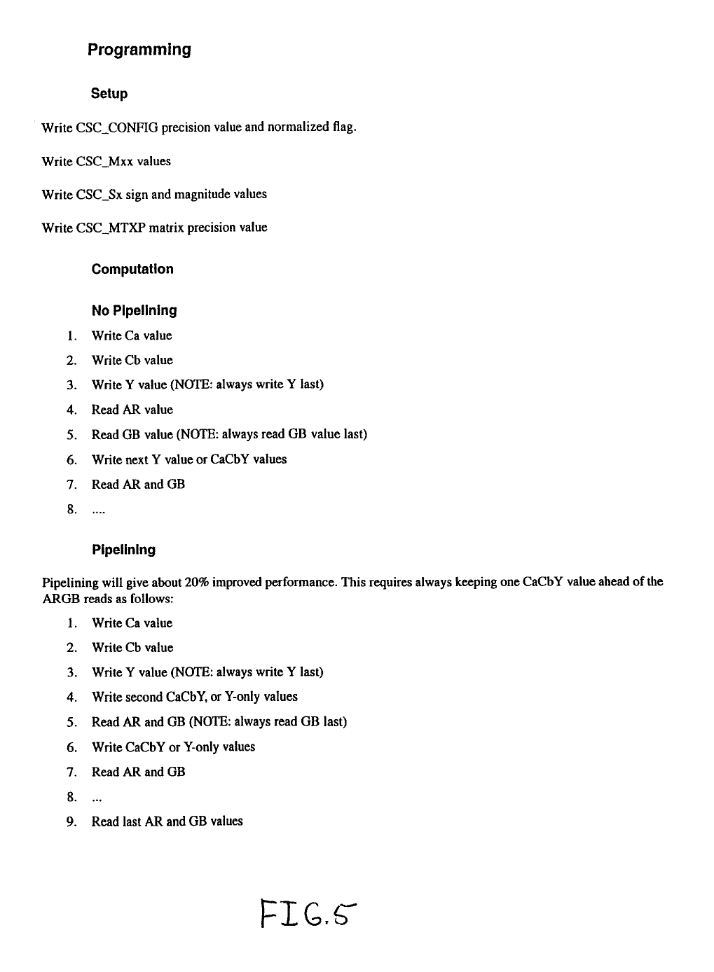

Shown in FIG. 5 are programming and configuration protocols for an embodiment of the conversion apparatus.

### DETAILED DESCRIPTION OF THE DRAWINGS

Although an embodiment of the conversion apparatus will be discussed in the context of the decompression of color image data and the conversion between color spaces, it should be recognized that the disclosed principles may be usefully applied in other contexts in which a rapid computation of an inverse DCT with an output in a standard format is needed.

Shown in FIG. 1 is a high level block diagram of an embodiment of the conversion apparatus 10. Block 12 represents the computation of the inverse DCT using the Winograd algorithm. In this embodiment of the conversion apparatus the output generated from the computations performed in block 12 is in the YCaCb color space. The input to block 12 is JPEG compressed YCaCb color space data. The Ca and Cb color space components may have been sub-sampled to reduce the amount of data. The human eye is less sensitive to the chrominance and hue components of the color space than the luminance component of the color space. The sub-sampling may be done, for example, by discarding the Ca and Cb data 3 out of every 4 pixels. It should be recognized that other sub-sampling schemes would be compatible with embodiments of the conversion apparatus or, no sub-sampling may be performed.

The Winograd algorithm is well suited to efficient computation of an inverse DCT. It is computationally efficient and relatively easily coded in assembly language. However, one drawback of its computation of the inverse DCT is that it provides the data in a non-standard format. Shown in FIG. 2A is the output format generated from block 12 for one component of the color space. The format of the output is the same for each component of the output YCaCb color space. Bit 100 is a sign bit. Bits 102 are 2 overflow bits. Bits 104 are 8 bits corresponding to an integer value between 128 to −127. Bits 106 are 5 bits corresponding to a fractional value. This format is converted for the performance of the color space conversion. Shown in FIG. 2B is a generalized representation of the assignment of the bits. It is possible for embodiments of the conversion apparatus to have varying number of in the output generated by block 12. In FIG. 2B, “p” represents the number of bits used to represent the fractional portion of the value generated by block 12.

Normalization and clipping block 14 represents the normalization process that converts the 16 bit values for each component of the color space and for each pixel into an 8 bit value ranging from 0 to 255. The normalization performed in normalization and clipping block 14 includes converting the 128 to −127 values to a corresponding value from 0 to 255. If the integer portion of the output generated by block 12 is already in the range from 0 to 255, the normalization is not performed. Shown in FIG. 3 is pseudo code representing the hardware operations performed by normalization and clipping block 14. The pseudo code shown in FIG. 3 represents the operations performed by the hardware in normalization and clipping block 14 to convert the 16 bit output generated by block 12 into a format that can be used in the color space conversion block 16.

Color space conversion block 16 performs a color space conversion by performing a matrix multiplication and adding an offset value. A 3 by 3 conversion matrix is used to convert the YCaCb color space data provided from normalization and clipping block 14 into components of the color space output from color space conversion block 16. In one embodiment of the conversion apparatus, the output color space generated from color space conversion block 16 is an RGB color space. It should be recognized that conversion to other color spaces could be performed. For example, in some applications it would be useful to have color space conversion block 16 convert from a YCaCb color space to a CMY color space. Provide below in equations 1-3 are the operations performed in color space conversion block 16. The operations performed to generate each component of the output color space include a matrix multiplication, addition of an offset, and a shift to create an 8 bit result.

R=(Sr+Y*M11+Ca*M12+Cb*M13)>>(5+Shift Precision) Eq. 1

G=(Sg+Y*M21+Ca*M22+Cb*M23)>>(5+Shift Precision) Eq. 2

B=(Sb+Y*M31+Ca*M32+Cb*M33)>>(5+Shift Precision) Eq. 3

In this equations, Sr, Sg, and Sb are offsets added in color space conversion block 16. M11 through M33 are the elements of the 3 by 3 matrix (the M array).

The output of the color space conversion block 16 is two words. One word includes the 8 bit R component and 8 bits of 0 s. This word is provided to the firmware as OR. The other word includes the 8 bit G component and the 8 bit B component. This word is provided to the firmware as GB. In the case of an underflow in the process, the hardware generates a 0 for the corresponding component. In the case of an overflow in the process, the hardware generates a 255 for the corresponding component.

The 3 by 3 array used in the matrix multiplication is generally written into color space conversion block 16 once during setup. All the values in the M array are 9 bits. The 9 bits include 8 bits of magnitude and 1 sign bit. All the values are in 0.8 format. That is, they represent values less than 1. For computation purposes they can be treated as 8 bit values. The Sr, Sg, and Sb values are all written as 16 bit values and a separate sign bit. These values are generally written once during setup.

The Y value provided to color space conversion block 16 is updated for every pixel. However, because of the possibility of sub-sampling, the Ca and Cb values may not be updated every pixel. For 4:1:1 sub-sampling, the same Ca and Cb values are used for 4 Y values. The hardware in normalization and clipping block 14 and in color space conversion block 16 is designed to compute the R, G, B values in minimum time for each pixel whether each of the Y, Ca, and Cb values have been written, or whether only the Y value has changed for the pixel. The Y values is updated last. The updating of the Y value is used to trigger the operation of normalization and clipping block 14 and color space conversion block 16. If the Ca and Cb values have not been updated, the hardware in normalization and clipping block 14 and block 16 uses the previous values to minimize processing time. All of the matrix computation performed in color space conversion block 16 is done with 18 bit precision so that overflows are kept. If an overflow occurs, the output for that component of the color space is clamped to 8′ hFF.

The hardware in normalization and clipping block 14 and color space conversion block 16 uses a data acknowledge handshake to insure that the processing is complete before the data can be read and to insure that the current results are read before new data can be written. Therefore, it is possible for the CPU to create a lockout condition. To address this, the hardware includes a 16 clock cycle timeout to prevent the lockout condition from lasting. A status bit is set if this occurs.

Shown in FIGS. 4A through 4D are register definitions for the hardware in normalization and clipping block 14 and color space conversion block 16. Shown in FIG. 5 are programming and configuration protocols for an embodiment of the conversion apparatus.

What is claimed is:

1. A method, comprising:
performing an inverse DCT upon data using processor executable instructions to generate a first result in a first color space; and
performing a conversion upon the first result using conversion hardware to generate a second result in a second color space.

2. The method as recited in claim 1, wherein:
performing the conversion includes performing a matrix multiplication for a color space conversion from the first color space to the second color space.

3. The method as recited in claim 2, wherein:
performing the inverse DCT includes using a Winograd process.

4. The method as recited in claim 3, wherein:
with the first result having a first format, performing the conversion includes converting the first result from the first format to a second format using the conversion hardware.

5. The method as recited in claim 4, wherein:
the first format includes a first plurality of data elements having an integer portion and a fractional portion; and
the second format includes a second plurality of data elements having an integer portion.

6. The method as recited in claim 5, wherein:
the first plurality of data elements each include 16 bits; and
the second plurality of data elements each include 8 bits.

7. The method as recited in claim 6, wherein:
the fractional portion of the first plurality of data elements includes 5 bits; and
the integer portion of the first plurality of data elements includes 8 bits.

8. The method as recited in claim 7, wherein:
the first color space includes a YCaCb color space; and
the second color space includes a RGB color space.

9. A conversion apparatus, comprising:
a formatting device arranged to receive decompressed data generated from the execution of processor executable instructions and configured to generate reformatted data from the decompressed data; and
a color space converter configured to perform a color space conversion on the reformatted data.

10. The conversion apparatus as recited in claim 9, wherein:
the color space converter includes a configuration to perform the color space conversion using a matrix multiplication.

11. The conversion apparatus as recited in claim 10, wherein:
the decompressed data includes a first plurality of data elements having an integer portion and a fractional portion; and
the reformatted data includes a second plurality of data elements; and
the formatting device includes a configuration to generate the second plurality of data elements having an integer portion.

12. The conversion apparatus as recited in claim 11, wherein:
the computer executable instructions include a configuration to generate the decompressed data by performing an inverse DCT using a Winograd process.

13. The conversion apparatus as recited in claim 12, wherein:
each of the first plurality of data elements includes 16 bits; and
each of the second plurality of data elements includes 8 bits.

14. The conversion apparatus as recited in claim 13, wherein:
the reformatted data includes YCaCb color space data.

15. The conversion apparatus as recited in claim 14, wherein:
the color space converter includes a configuration to convert the reformatted data to RGB color space data.

16. A data pipeline, comprising:
a processing device configured to execute instructions to compute an inverse DCT using a Winograd process to generate decompressed YCaCb color space data in a first format;
a converter configured to change the YCaCb color space data from the first format to a second format; and
a color space converter configured to generate RGB color space data from the YCaCb color space data in the second format.

17. The data pipeline as recited in claim 16, wherein:
the YCaCb color space data in the first format includes a first set of data elements each having 16 bits; and
the YCaCb color space data in the second format includes a second set of data elements each having 8 bits.

18. The data pipeline as recited in claim 17, wherein:
the first set of data elements each include an integer portion and a fractional portion; and
the second set of data elements each include an integer portion.

19. The data pipeline as recited in claim 18, wherein:
the color space converter includes a configuration to generate RGB color space data from the YCaCb color space data in the second format using a matrix multiplication.

20. An apparatus, comprising:
means for executing code to perform an inverse DCT to generate data in a first format;
means for converting the data in the first format to the data in a second format; and
means for performing a color space conversion on the data.

21. The apparatus as recited in claim 20, wherein:
the data in the first format includes a first plurality of data elements having an integer portion and a fractional portion; and
the data in the second format includes a second plurality of data elements having an integer portion.
